(19) United States
(12) Patent Application Publication
(10) Pub. No.: US 2014/0029467 A1
(43) Pub. Date: Jan. 30, 2014

(54) ZONING RECORD UPDATE

(71) Applicants: Balaji NATRAJAN, Spring, TX (US); Michael G. Myrah, Cypress, TX (US); Sohail Hameed, Houston, TX (US)

(72) Inventors: Balaji NATRAJAN, Spring, TX (US); Michael G. Myrah, Cypress, TX (US); Sohail Hameed, Houston, TX (US)

(21) Appl. No.: 13/557,443

(22) Filed: Jul. 25, 2012

(51) Int. Cl. H04L 12/28

(52) U.S. Cl. 370/254

(57) ABSTRACT

An example first switch includes a zoning manager module to store a record comprising zoning information of a serial attached SCSI (SAS) fabric. The zoning manager module updates the record based at least in part on received zone modification information to create an updated record. The zone manager module distributes the updated record to at least a second switch in the SAS fabric, wherein the first switch and the second switch are in a stacked configuration.

### BACKGROUND

A switched fabric is a network topology where multiple network nodes are connected to one another via one or more network switches and one or more physical links. For example, in the context of a large serial attached SCSI (SAS) fabric, multiple initiator devices may connect with multiple target devices via one or more SAS switches and one or more corresponding physical links. The initiator devices may be, for example, host bus adapters (HBAs) and/or data storage controllers, and the target devices may be, for example, end devices such as SAS hard disk drives, serial ATA (SATA) hard disk drives, solid state disks (SSDs), and/or SAS tape drives (also referred to collectively as JBODs). Each SAS switch may forward data received from the initiator devices to the target devices, and, conversely, forward data received from the target devices to the initiator devices. Because the number of devices in a SAS fabric may become quite large, zoning may be utilized to manage traffic and security. In particular, zoning may be utilized in large topologies to break the topology into logical zone groups and allow controlled access within and between the zone groups.

### BRIEF DESCRIPTION OF THE DRAWINGS

Examples are described in the following detailed description and in reference to the drawings, in which:

FIG. 1 depicts an example system in accordance with an implementation;

FIG. 2 depicts an example process associated with a switch in accordance with an implementation;

FIG. 3 depicts an example process associated with switches in a fabric in accordance with an implementation;

FIG. 4 depicts an example switch in accordance with an implementation;

FIG. 5 depicts an example zoning record in accordance with an implementation; and

FIG. 6 depicts an example modified zoning record in accordance with an implementation.

### DETAILED DESCRIPTION

Various aspects of the present disclosure are directed to an efficient and effective distributed zoning approach. In particular, various aspects of the present disclosure are directed to a distributed zoning approach that, among other things, enables individual switches in a fabric to zone their own local fabrics in response to receiving an updated zoning record from another switch in the fabric.

In large SAS storage networks. SAS switches may be “stacked” together (i.e., trunked or daisy chained together) to enable communication between the SAS switches and the devices in their respective local fabrics. While this stacking approach allows greater access from a given initiator, it makes conventional zoning approaches inefficient. In particular, the conventional approach of utilizing of a single zoning manager to zone an entire fabric may be inefficient because, if each local fabric is at a maximum configuration, the sequential nature of the zoning operation may be time consuming, inefficient, and potentially result in timeouts.

Various aspects of the present disclosure address at least the above by distributing zoning processes among multiple switches in a SAS fabric such that zoning may be conducted by zoning mangers in individual switches in a parallel manner. More specifically, in various aspects of the present disclosure, upon receiving zoning modifications from an administrator at a first switch, the first switch may distribute the zoning modification information in the form of an updated zoning record to the other switches in the fabric. Each switch may then conduct local zoning operations based thereon, as well as update their stored zoning record to reflect the current zoning configuration. This novel and previously unforeseen approach is described in detail below with reference to various examples and various figures.

In one example in accordance with the disclosure, a first switch is provided. The first switch comprises a zoning manager module to store a record comprising zoning information of a SAS fabric. The zoning manager module updates the record based at least in part on received zone modification information to create an updated record. Further, the zone manager module distributes the updated record to at least a second switch in the SAS fabric, where the first switch and the second switch are in a stacked configuration.

In another example in accordance with the disclosure, a method is provided. The method comprises storing, at a first switch, a record comprising zoning information of a SAS fabric. Additionally, the method comprises receiving, at the first switch, a zoning modification with respect to the SAS fabric, and updating the record comprising the zoning information to reflect the zoning modification with respect to the SAS fabric. The method further comprises providing, by the first switch, a command to at least one device in a local fabric associated with the first switch based at least in part on the updated record, and distributing the updated record to at least one other switch in the SAS fabric.

In yet another example in accordance with the disclosure, a non-transitory machine-readable medium is provided. The machine-readable medium comprises instructions which, when executed, cause a switch to update a stored record based on received zoning change information, and provide commands to at least one device in a local fabric based at least in part on the received zoning change information. The instructions further cause the switch to distribute an updated record to at least one other switch, wherein the switch and the at least one other switch are in a stacked configuration.

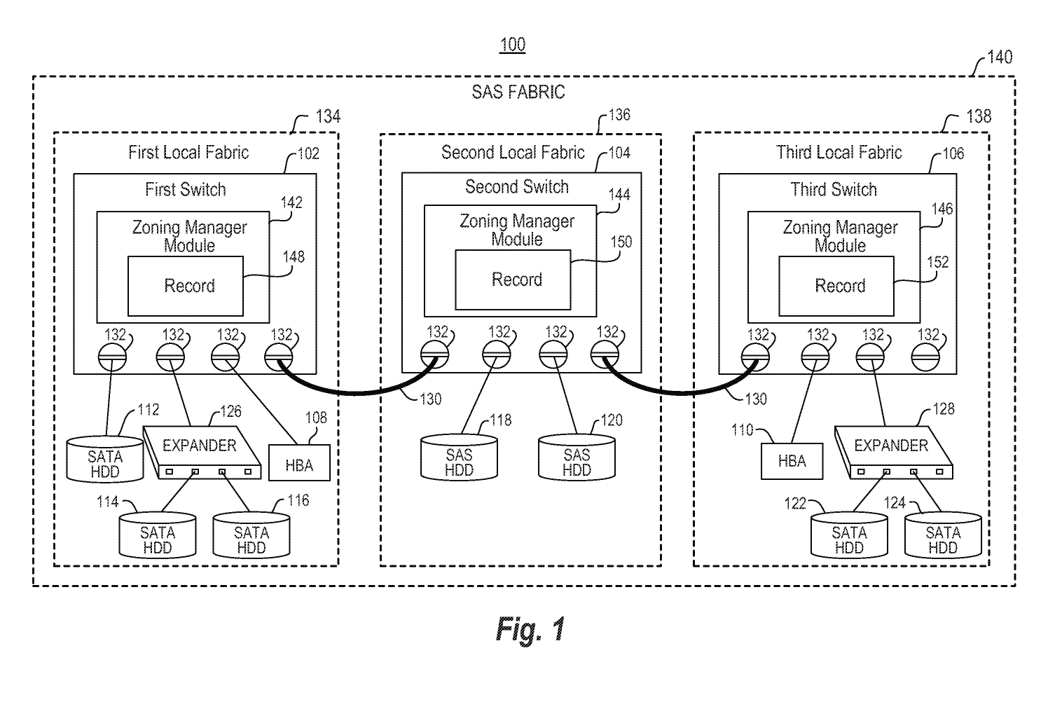

FIG. 1 depicts an example system 100 in accordance with an implementation. It should be readily apparent that the system 100 represents a generalized illustration and that other elements may be added or existing elements may be removed, modified, or rearranged without departing from the scope of the present disclosure. For example, while the system 100 depicted in FIG. 1 includes only three switches 102-106, the system may actually comprise many more switches, and only three have been shown and described for simplicity.

The system 100 generally comprises switches 102-106 (e.g., SAS switches), initiators (e.g., HBAs 108-110), targets (e.g., 112-124), and expanders (126-128). More specifically, a first switch 102 may be stacked (i.e., trunked or daisy-chained) with a second switch 104 which itself is stacked with a third switch 106. The connection therebetween may be made via a trunk line 130 that connects ports 132 of the respective switches 102-104. Each switch may facilitate communication between the various initiators (e.g., HBAs 108-110), targets (e.g., 112-124), expanders (e.g., 126-128), and other switches (e.g., 102-106) connected thereto. Further, each switch may be responsible for configuring the devices in its own local fabric via a zoning manager module therein. For example, the first switch 102 may be responsible for configuring the devices in the first local fabric 134 via the zoning manager module 142, wherein the devices within the first local fabric 134 comprise the SAS HDD 11, expander 126, SATA HDDs 114-116, and HBA 108. Similarly, the second switch 104 may be responsible for configuring the devices in the second local fabric 136 via the zoning manager module 144, wherein the devices in the second local fabric 136 comprise the SAS HDDs 118-120. Likewise, the third switch 106 may be responsible for controlling the devices in the third local fabric 138 via the zoning manager module 146, wherein the devices in the third local fabric 138 comprise the HBA 110, expander 128, and SATA HDDs 122-124. Each of the first local fabric 134, second local fabric 136, and third local fabric 138 may form part of the entire SAS fabric 140.

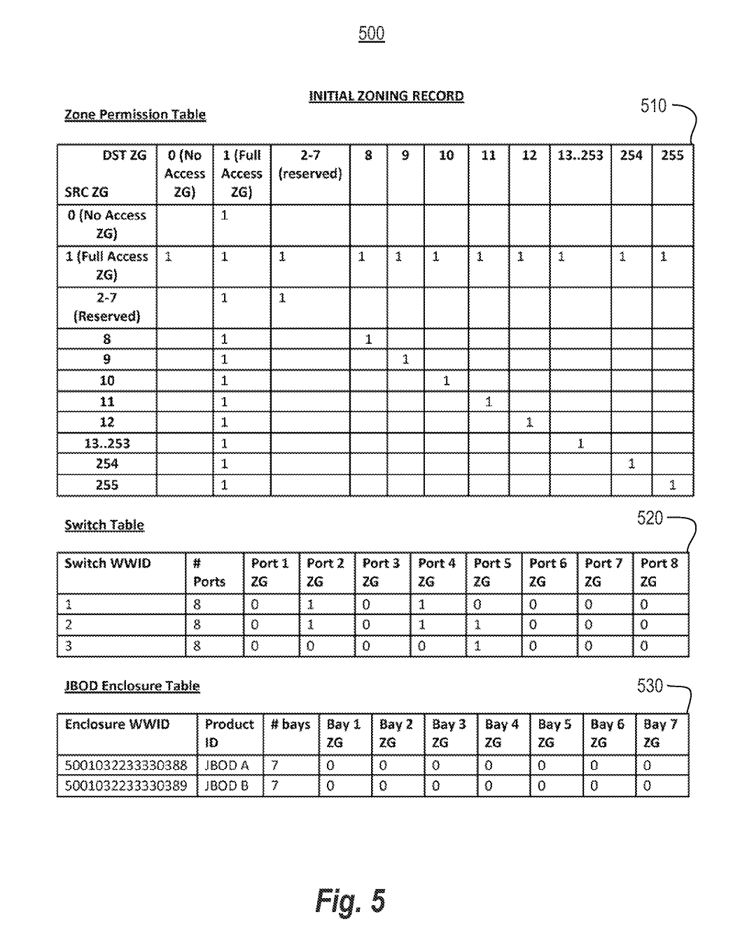

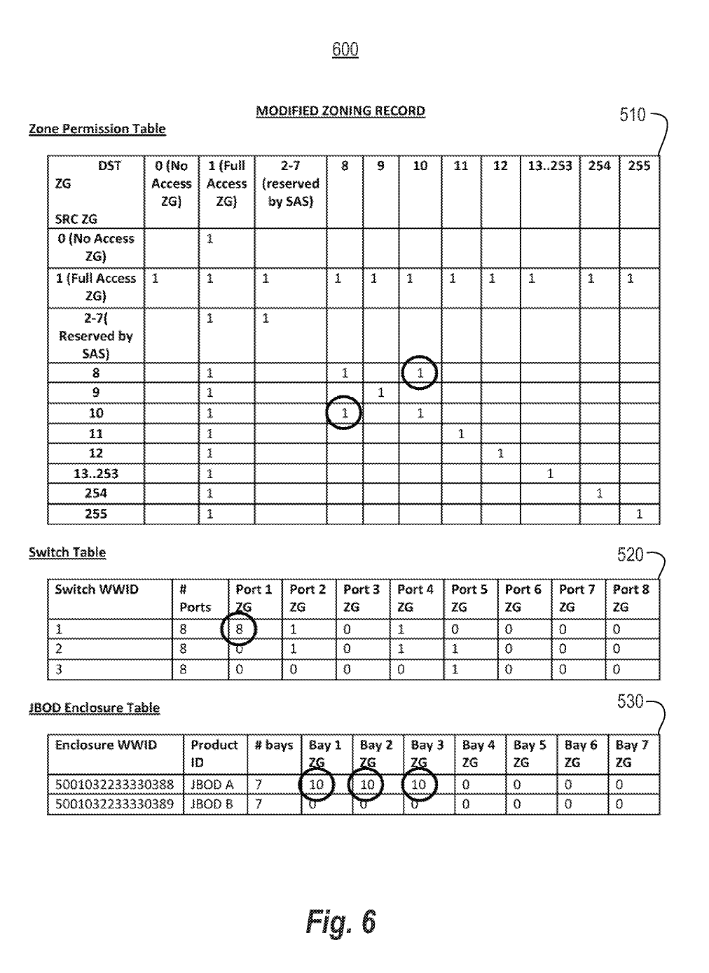

The zoning manager module 142-146 of each switch 102-104 may be responsible for configuring the devices in its own local fabric as well as communicating zoning changes to other zoning manger modules so those zoning manger modules may similarly configure devices in their respective local fabrics, In particular, each zoning manger module 142-146 may comprise hardware, software, or a combination thereof that stores a record 148-152 for the entire SAS fabric 140 (e.g., a persistent zone group record (PZR), wherein a PZR is understood herein to be a record that comprises the zone group settings and/or access privileges with respect to devices in the SAS topology). This record 148-152 may be in the form of a database, and comprise information such as a zone permission table, a switch table, and/or a JBOD enclosure table (described in greater detail below with respect to FIGS. 5 and 6). The zoning manager modules 142-146 may allow an administrator to update or otherwise modify the records 148-152 via an interface such as a graphical user interface (GUI)or command line interface (CLI). In response to such a modification, the zoning manger modules may update its local fabric based thereon as well as distribute the updated record to other zoning manger module in the SAS fabric 140 so they may similarly update their local fabric.

For example, an administrator may utilize a GUI to access the first switch 102. The administrator may provide zoning modification instructions via the GUI such as assigning an initiator to a switch and assigning a target to the initiator. In response to this update, the first switch 102 may update the PZR stored in the first switch 102. In addition, if the changes are to be applied to any devices attached to the first switch 102 (e.g., initiators and targets), the first switch 102 may issue commands (e.g., SMP zoning commands) to these devices in the first local fabric 134 to configure the devices in accordance with the updated PZR. Furthermore, the first switch 134 may distribute the updated PZR to the zoning manager module 144 of the second switch 104 and the zoning manger module of the third switch 106. Each of these switches (104-106) may update their respective PZRs based on the received updated PZR from the first switch 102, as well as issue commands (e.g., SMP zoning commands) to the devices in their local fabrics 136-138 to configure the devices in accordance with the updated PZR, if such changes are to he applied to devices in their respective local fabrics. Among other things, this distributed approach allows consistency in PZRs at the various switches in the SAS fabric 140, as well as efficient zoning configuration of the local fabrics that form the overall SAS fabric.

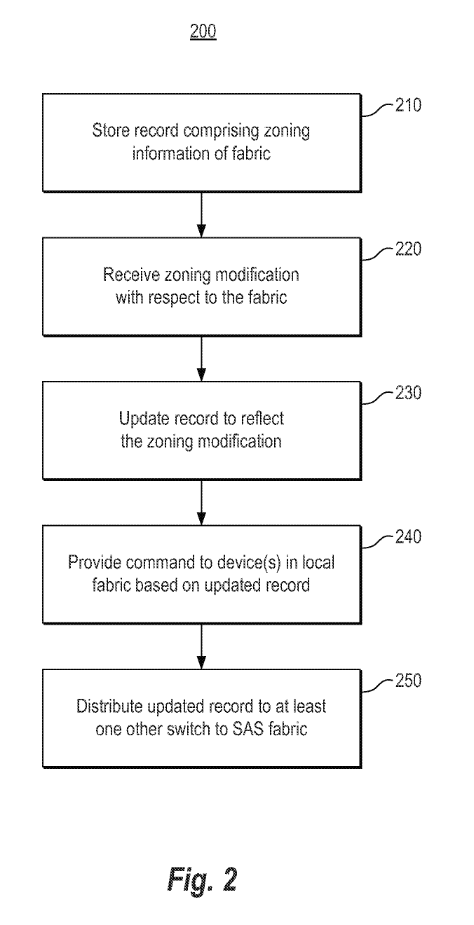

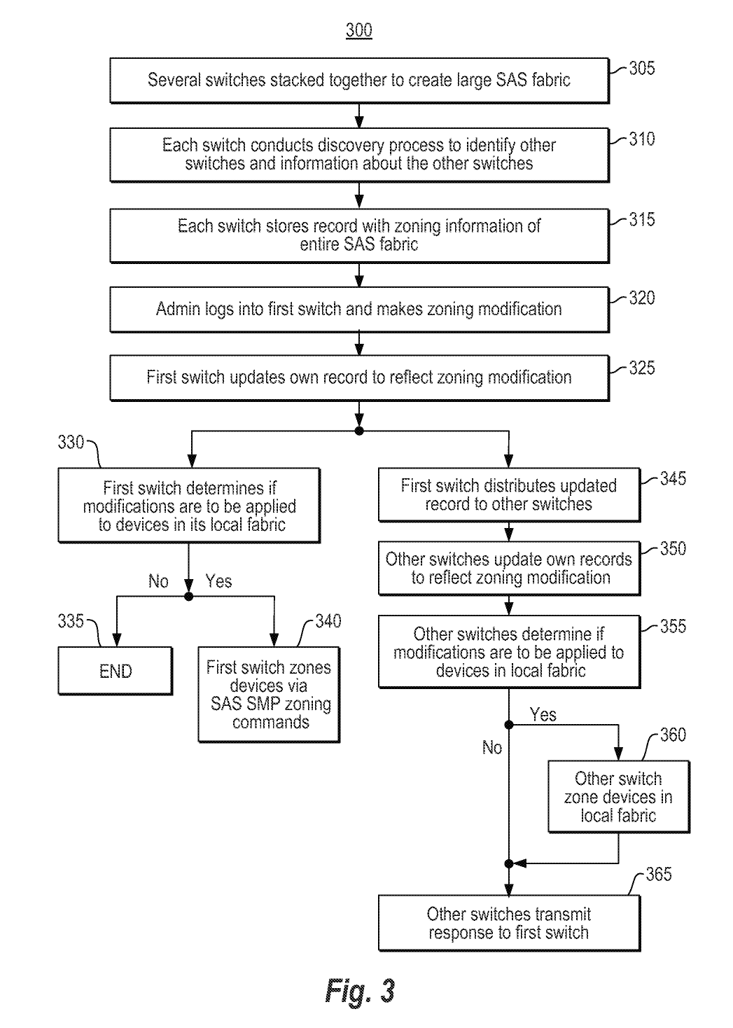

FIG. 2 depicts an example process 200 associated with a switch in accordance with an implementation. It should be readily apparent that the processes depicted in FIG. 2 (as well as FIG. 3) represent generalized illustrations, and that other processes may be added or existing processes may be removed, modified, or rearranged without departing from the scope and spirit of the present disclosure. Further, it should be understood that the processes may represent executable instructions stored on memory that may cause at least one processing device to respond, to perform actions, to change states, and/or to make decisions. Thus, the described processes may be implemented as executable instructions and/or operations provided by a memory associated with a switch. Moreover, the processes may represent functions and/or actions performed by functionally equivalent circuits like an analog circuit, a digital signal processing device circuit, an application specific integrated circuit (ASIC), or other logic devices associated with a switch. Furthermore. FIGS. 2 and 3 are not intended to limit the implementation of the described examples, but rather the figure illustrates functional information one skilled in the art could use to design/fabricate circuits, generate software, or use a combination of hardware and software to perform the illustrated processes.

The process 200 may begin at block 210, when a switch stores a record (e.g., a PZR) comprising zoning information or settings for a fabric (e.g., a SAS fabric). This record may be an initial zoning configuration for the fabric, and may be provided by a default setting, or by an administrator via an interface such as a GUI or CLI. The record may be in the form of a database, and comprise information such as a zone permission table, a switch table, and/or a JBOD enclosure table, for example. The record may be utilized by a zoning manager module of the switch to configure devices in the fabric.

At block 220, the switch may receive a zoning modification with respect to the fabric. In particular, the switch may comprise a communication interface (e.g., port, PHY, and/or transceiver) that allows the switch to receive zoning modification information provided by an administrator via, e.g., a. GUI or CLI. The zoning modification information may be, for example, information pertaining to the allocation and/or deallocation of disk drives within the fabric. Alternatively or in addition, the zoning modification information may be, for example, information pertaining to the movement of disk drives in response to a failure such as a server failure.

At block 230, in response to receiving the zoning modification with respect to the fabric, the switch may update the stored record to reflect the zoning modification with respect to the fabric. That is, the switch may update the stored record based on the changes made by, e.g., the administrator, with the result being an updated record.

At block 240, the switch may provide a command to the devices in its local fabric based on the updated record. More specifically, the switch may transmit SAS SMP zoning commands to the devices in its local fabric. Such commands may be limited to the switch's local fabric and may not cross a switch boundary. For example, with reference to FIG. 1 the first switch 102 may transmit SAS SMP zoning commands to the devices within the first local fabric 134 and not transmit such commands to devices in the second local fabric 136 or third local fabric 138. Furthermore, in some implementations, the switch may determine whether any of the zoning modifications in the updated record are applicable to the devices in the switch's local fabric, and only transmit SAS SMP zoning commands to the devices if the changes are to be applied to those devices attached to switch. Thus, if the switch determines that none of the zoning modifications are applicable to devices in its local fabric, the switch may forgo sending out SAS SMP zoning commands and instead proceed to other processes such as distributing the updated record to other switches, as discussed below. Alternatively, such processes may also occur before or in parallel.

At block 250, the switch may distribute the updated record to at least one other switch in the SAS fabric. A zoning manager module at the other switches may receive the updated record and update their respective record to reflect the changes. Furthermore, the zoning manager modules may determine whether any of the changes are to be applied to any devices in their local fabric and, if so, transmit commands such as SAS SMP zoning commands to the devices to zone the devices based on the updated record. In some implementations, the switch may only transmit the updated record to switches that include zoning manager modules. The switch may determine whether the switches include such modules via a SAS discovery process. Furthermore, it should be understood that this process described with respect to block 250, as mentioned above, may occur before, after, or in parallel with the process described with respect to block 240, such that zoning operations for the entire fabric may be conducted simultaneously or in parallel at each switch in the SAS fabric in a distributed manner.

FIG. 3 depicts another example process 300 associated with switches in a fabric in accordance with an implementation. As mentioned above, the processes depicted represent generalized illustrations, and other processes may be added or existing processes may he removed, modified, or rearranged without departing from the scope and spirit of the present disclosure. Furthermore, the processes are not intended to limit the implementation of the described examples, but rather to illustrate functional information one skilled in the art could use to design/fabricate circuits, generate software, or use a combination of hardware and software to perform the illustrated processes.

The process may begin at block 305, where several SAS switches are stacked together to create a large SAS fabric. This may also be understood as a daisy-chained or trunked configuration, like shown in FIG. 1, where trunked lines couple the ports of the switches in a serial configuration to expand the overall fabric.

At block 310, the switches conduct a discovery process to identify other devices in the fabric as well as information about the other devices. For example, each switch may initiate a SAS discovery process to identify the other switches in the fabric, as well as identify information such as the SAS address of each switch and/or whether or not the each switch includes a zoning manager module.

At block 315, each switch stores a record with zoning information of the entire SAS fabric (e.g., a PZR). This record may include initial zoning information for the SAS fabric as set by an administrator, another network device, and/or as a default setting. In addition, this record may be created based on information provided at a first switch and distributed to the other switches by the first switch.

At block 320, an administrator may log into a first switch and make zoning modifications with respect to the fabric. The first switch may be any of the switches in the fabric that comprises a zoning manager module. The modifications may be, for example, information pertaining to the allocation and/or deallocation of a disk drive to/from initiators within the fabric. The modifications may be in response to, e.g., load balancing issues, fault-tolerance issues, failure issues, new hardware, or the like. In one implementation, the administrator may log into the switch via a GUI, CLI, or the like.

At block 325, the first switch updates its stored record to reflect the zoning modifications made by the administrator. This process may involve updating the record to specify the current zoning configuration of the fabric as setup by the administrator. In addition, this process may result in an updated record that is stored at the first switch.

At block 330, the first switch may analyze the updated record to determine if the zoning modifications are with respect to its attached devices. These attached devices may be, e.g., target devices and/or initiator devices directly or indirectly attached to the first switch and that are within its local fabric. In some implementations, the analysis may involve the first switch comparing the updated record with the previous record to identify changes and determining if any of those changes are to be applied to any devices attached to the switch.

At block 340, if the first switch determines that at least some of the changes are to be applied to at least one device attached to the switch, the first switch may zone the device(s) by issuing, e.g., SAS SMP zoning commands based on the updated record. If, on the other hand, the first switch determines that at least sonic of the changes are not to be applied to at least one device attached to the switch, this portion of the process may be complete for the first switch as shown in block 325.

Prior to, at the same time, or after the processes shown in blocks 330 and/or 340, the first switch may distribute the updated record to the other switches in the fabric at block 345. The other switches may be known to the first switch via the discovery process described above with respect to block 310. Further, in some implementations, the first switch may only distribute the updated record to switches that have zoning manager modules previously identified during the discovery process.

At block 350, upon receiving the updated record from the first switch, the other switches in the fabric may update their respective record to reflect the zoning modifications. Hence, each switch in the fabric may have a record with the same contents. Put another way, each switch in the fabric may have the same zoning information of the entire fabric in response to processes described with respect to FIG. 3.

At block 355, the other switches may determine if the zoning modifications are to be applied to devices in their local fabrics. Similar to the processes described above with respect to block 330, each switch may compare their updated record with the previous record to identify changes and determine if any of those changes are to be applied to any devices attached to the switch.

At block 360, if the other switches determine that at least some of the zoning changes are to be applied to at least one attached device, the respective switch may zone the device(s) by issuing, e.g., SAS SMP zoning commands based on the updated record.

At block 365, the other switches may each transmit a response to the first switch that transmitted the updated record. The response may include acknowledgement that the switch received the updated record. Alternatively or in addition, the response may include an indication that the switch updated its stored record to reflect the modifications in the updated record. Alternatively or in addition, the response may include an indication that the switch zoned attached devices based on the updated record. Alternatively or in addition, the response may include an indication that an error occurred and/or information about the error.

While not shown in FIG. 3, each switch in the fabric may provide the capability to report to an administrator and/or another device whether a zoning operation was successful or not. For example, the above-mentioned first switch may report to the admin via a GUI or CLI that the zoning modification was successful upon receiving indications to this effect from the respective stacked switches as well as knowledge of its own operations. The administrator may than logout of the switch knowing that the requested zoning modifications were properly conducted.

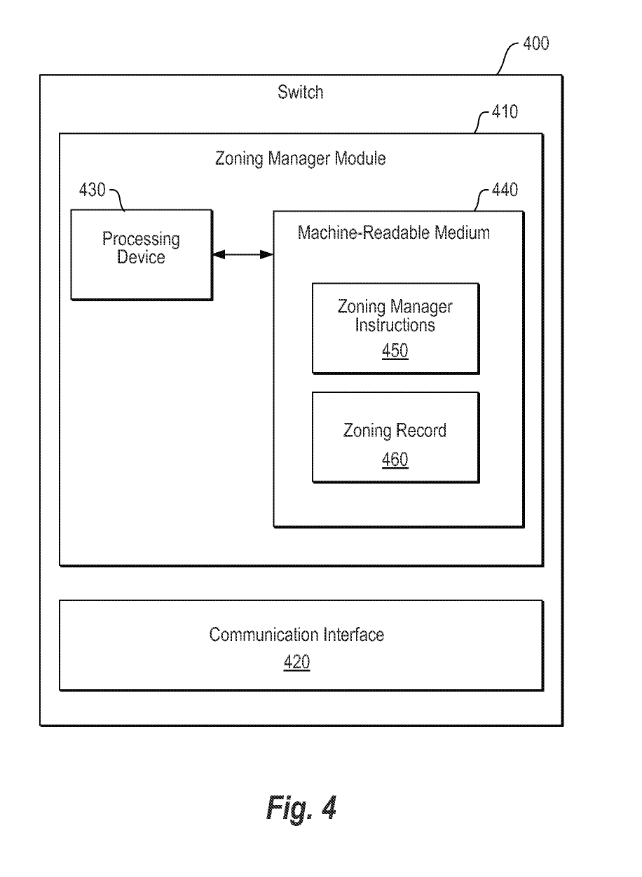

FIG. 4 depicts an example switch 400 in accordance with an implementation. The switch may comprise a zoning manager module 410 and a communication interface 420 communicatively coupled to each other. The zoning manage module 410 may comprise a processing device 430 and a non-transitory machine-readable medium 440, The machine-readable medium 440 may comprise zoning manager instructions 450 that when executed cause the switch to conduct at least the functions described above with respect to FIGS. 1-3. Additionally, the machine-readable medium 440 may comprise a zoning record (e.g., a PZR) that describes the zoning configuration of the entire fabric, and that may be updated and distributed by the switch as described above. The machine-readable medium 440 may correspond to any typical storage device that stores machine-readable instructions, such as programming code, software, firmware, or the like. For example, the machine-readable medium 440 may include one or more of a non-volatile memory, a volatile memory, and/or a storage device. Examples of non-volatile memory include, but are not limited to, electronically erasable programmable read only memory (EEPROM) and read only memory (ROM). Examples of volatile memory include, but are not limited to, static random access memory (SRAM) and dynamic random access memory (DRAM). Examples of storage devices include, but are not limited to, hard disk drives, compact disc drives, digital versatile disc drives, optical devices, and flash memory devices. In some implementations, the instructions may be part of an installation package that can be executed by the processing device 430. In this case, the machine-readable medium 440 may be a portable medium such as a CD, DVD, or flash drive or a memory maintained by a server from which the installation package can be downloaded and installed. In another implementation, the instructions may be part of an application or application already installed. Here, the machine-readable medium 440 may include integrated memory such as a hard drive.

The processing device 430 may be a at least one of a central processing unit (CPU), a semiconductor-based microprocessor, a graphics processing unit (GPU), a field-programmable gate array (FPGA) configured to retrieve and execute instructions, other electronic circuitry suitable for the retrieval and execution instructions stored on a machine-readable storage medium, or a combination thereof. The processing device 430 may fetch, decode, and execute instructions stored on the storage medium 440 to implement the functionalities described above, such as updating a zoning record, issuing zoning commands to devices in a local fabric based on an updated zoning record, and/or distributing an updated zoning record to other switches in a fabric.

FIG. 5 depicts an example zoning record 500 in accordance with an implementation. The zoning record 500 is directed to a fabric with 3 trunked or stacked switches with 2 attached JBODs. The information within these respective tables may be based on the default and/or initial configuration of the fabric, It should be understood that this zoning record 500 is exemplary, and other configurations and/or information may be utilized in accordance with various implementations of the present disclosure.

The zoning record 500 comprises a zone permission table 510, a switch table 520, and a JBOD enclosure table 530.

The zone permission table 510 generally specifies access privileges between source (“SRC”) and destination (“DST”) zone groups, where there may be up to 256 source/destination zone groups within the fabric, and where a value of “1” indicates that devices assigned to a particular source zone group have access to devices assigned to a particular destination zone group. More specifically, the zone permission table 510 indicates that the devices in source zone group “1” have access to all other zone groups and vice versa. Further, the zone permission table 510 indicates that each source zone group has self-access by the inclusion of “1” at each identical source and destination group (e.g., source zone group 8::destination zone group 8=“1”).

The switch table 520 generally specifies a correspondence between switches and their respective ports and assigned zone groups, where any device attached to a specified switch port may inherit the assigned zone group. Here, there are 3 trunked switches each with 8 ports and 2 JBODs. The ports that are utilized to trunk the switches are assigned to zone group “1”. For example, switch 1 is trunked to switch 2 via port 4 and switch 2 is trunked to switch 3 via port 5. Thus, port 4 on switches 1 and 2, and port 5 on switches 2 and 3 are zone group “1”. Further, the ports attached to the JBODs are also assigned to zone group “1”. Therefore, if JBOD A is attached to port 2 on switch 1 and JBOD B is attached to port 2 on switch 2, port 2 on switches 1 and 2 are assigned to zone group “1”.

The JBOD enclosure table 530 generally specifies a correspondence between drive bays of a JBOD enclosure and zone groups, In the example shown, none of the drive bays of a JBOD enclosure are assigned to a particular zone group.

FIG. 6 depicts an example modified zoning record 600 in accordance with an implementation. The zoning record 600 is similar to the record depicted in FIG. 5 but with a few modifications. In particular, the modified zoning record 600 reflects modification after attaching an initiator 1 to switch 1 at port 1 (zone group =8) and assigning JBOD A bays 1-3 (zone group=10) to initiator 1. As can be seen with respect to the zone permission table 510, source zone group 8 is given permission to destination zone group 10, and vice versa. Additionally, with respect to the switch table 520, port 1 of switch 8 is assigned to zone group 8. Still further, with respect to the JBOD enclosure table, bays 1-3 of JBOD A are assigned to zone group 10.

The changes shown in FIG. 6 are changes that may be made by an administrator via a GUI or CLI linked to one of the switches in the fabric. As described in detail above, such modifications may be stored at the switch in the form of an updated zoning record, and may cause the switch to configure its local fabric based thereon, as well as distribute this updated record to the other switches in the fabric so that each may update their zoning record for the fabric based thereon, as well as configure their local fabric if their respective attached devices in the their local fabric are modified by the zoning change. Hence, the present disclosure provides an efficient and effective manner to distribute zoning operations among switches in the fabric to improve network performance. This may enable less development and debugging of complex system level issues that may result intermitted timeouts in large fabrics that utilize centralized zoning approaches.

While the above disclosure has been shown and described with reference to the foregoing examples, it should be understood that other forms, details, and implementations may be made without departing from the spirit and scope of the disclosure that is defined in the following claims.

What is claimed is:

1. A method comprising:
storing, at a first switch, a record comprising zoning information of a serial attached SCSI (SAS) fabric;
receiving, at the first switch, a zoning modification with respect to the SAS fabric;
updating, by the first switch, the record comprising the zoning information to reflect the zoning modification with respect to the SAS fabric;
providing, by the first switch, a command to at least one device in a local fabric associated with the first switch based at least in part on the updated record; and
distributing, by the first switch, the updated record to at least one other switch in the SAS fabric.

2. The method of claim 1, further comprising:
updating, by the at least one other switch in the SAS fabric, a record comprising zoning information stored at the at least one other switch based at least in part on the updated record received from the first switch; and
providing, by the at least one other switch, a command to at least one device in a local fabric associated with the at least one other switch based at least in part on the updated record.

3. The method of claim 1, further comprising receiving, at the first switch and from the at least one other switch, a response from the at least one other switch indicating whether a record at the at least one other switch was modified based least in part on the updated record.

4. The method of claim 1, further comprising discovering, by the first switch, the at least one other switch in the SAS fabric via a SAS discovery process.

5. The method of claim 4, further comprising discovering, by the first switch, which of the at least one other switch comprises a zone manager, and distributing the updated record to only the at least one other switch that comprises a zone manager.

6. The method of claim 1, wherein the command is a SAS serial management protocol (SMP) zoning command.

7. The method of claim 1, wherein the record comprises a persistent zone group record.

8. The method of claim 1, wherein the first switch and the at least one other s are arranged in a stacked configuration.

9. The method of claim 1, wherein the record is stored and updated by a zone manager of the first switch.

10. A first switch comprising:
a zoning manager module to
store a record comprising zoning information of a serial attached SCSI (SAS) fabric;
update the record based at least in part on received zone modification information to create an updated record;
distribute the updated record to at least a second switch in the SAS fabric,
wherein the first switch and the second switch are in a stacked configuration.

11. The first switch of claim 10, wherein the zoning manager is further to provide a serial management protocol (SMP) zoning command to at least one device in a local fabric associated with the first switch based at least in part on the zone modification information.

12. The first switch of claim 10, wherein the zoning manager is further to receive a response from the second switch indicating that a record of the second switch was modified based least in part on the updated record.

13. The first switch of claim 10, wherein the first switch further comprises an interface to receive the zone modification information.

14. The first switch of claim 10, wherein the record comprises a persistent zone group record.

15. The first switch of claim 10, wherein the zoning module is further to discover the second switch via a SAS discovery process, and determine whether the second switch comprises a zoning manager module.

16. A non-transitory machine-readable medium comprising instructions, which when executed, cause a switch to:
update a stored record based on received zoning change information;
provide commands to at least one device in a local fabric based at least in part on the received zoning change information; and
distribute an updated record to at least one other switch,
wherein the switch and the at least one other switch are in a stacked configuration.

17. The non-transitory machine-readable medium of claim 16, wherein the switch and at least one other switch are part of a serial attached SCSI (SAS) fabric.

18. The non-transitory machine-readable medium of claim 16, wherein the at least one other switch updates a record based on the updated record received from the switch.

19. The non-transitory machine-readable medium of claim 16, wherein the switch and the at least one other switch are SAS switches.

20. The non-transitory machine-readable medium of claim 16, wherein the zoning change information comprises at least one of an allocation and deallocation of a disk drive within a serial attached SCSI (SAS) fabric.
